(19) United States
(12) Patent Application Publication
(10) Pub. No.: US 2022/0073698 A1
(43) Pub. Date: Mar. 10, 2022

(54) BORON NITRIDE POWDER AND RESIN COMPOSITION

(71) Applicant: Denka Company Limited, Chuo-ku, Tokyo (JP)

(72) Inventors: Yusuke SASAKI, Machida-city, Tokyo (JP); Fumihiro KUROKAWA, Machida-city, Tokyo (JP); Kohki ICHIKAWA, Machida-city, Toyko (JP)

(73) Assignee: Denka Company Limited, Chuo-ku, Tokyo (JP)

(21) Appl. No.: 17/423,256

(22) PCT Filed: Jan. 28, 2020
(86) PCT No.: PCT/JP2020/003043

§ 371 Date: Jul. 15, 2021

(30) Foreign Application Priority Data
Jan. 29, 2019 (JP) 2019-013379

(51) Int. Cl. C08K 3/38; C01B 21/064; C08G 59/40; C08G 59/20; C08K 7/18

(52) U.S. Cl. CPC C08K 3/38; C01B 21/0646; C08G 59/4014; C08K 2201/001; C08K 7/18; C08K 2003/385; C08G 59/20

(57) ABSTRACT

One aspect of the present invention is a boron nitride powder composed of aggregates of primary particles of boron nitride, wherein the boron nitride powder has an average diameter of 40 μm or more and an average sphericity of less than 0.70.

### TECHNICAL FIELD

The present invention relates to a boron nitride powder and a resin composition.

### BACKGROUND ART

In an electronic component such as a power device, a transistor, a thyristor, and a CPU, efficient dissipation of heat generated during use is a problem. In order to solve this problem, conventionally, an insulating layer of a printed wiring board on which an electronic component is mounted is made to have high thermal conductivity, and the electronic component or the printed wiring board is attached to a heat sink via an electrically insulating thermal interface material. Ceramic powder having high thermal conductivity is used for the insulating layer and the thermal interface material.

As the ceramic powder, a boron nitride powder having characteristics such as a high thermal conductivity, a high insulating property, and a low relative dielectric constant has attracted attention. For example, Patent Document 1 discloses a hexagonal boron nitride powder in which the ratio of the major axis to the thickness of the primary particles is 5 to 10 on average, the size of the aggregates of the primary particles is 2 μm or more and 200 μm or less in terms of average particle diameter (D50), and the bulk density is 0.5 to 1.0 g/cm³, as a hexagonal boron nitride powder in which the shape of the aggregates is more spherical to improve the packing property and powder strength.

### CITATION LIST

### Patent Document

[Patent Document 1] Japanese Patent Application Laid-Open No. 2011-98882

### SUMMARY OF INVENTION

### Technical Problem

In recent years, the importance of heat dissipation has further increased with an increase in the speed and integration of circuits in electronic components and an increase in the mounting density of electronic components on printed wiring boards. Therefore, a boron nitride powder having a higher thermal conductivity than ever before is required.

Accordingly, the present invention aims to improve the thermal conductivity of boron nitride powder.

### Solution to Problem

As a result of investigation for solving the above-described problems, the present inventors have found that, in addition to the fact that it is effective to increase the average diameter of the boron nitride powder, surprisingly, in the boron nitride powder having a large average diameter, the average sphericity smaller than a predetermined value is advantageous for improving the thermal conductivity.

That is, one aspect of the present invention is a boron nitride powder composed of aggregates of primary particles of boron nitride, wherein the boron nitride powder has an average diameter of 40 μm or more and an average sphericity of less than 0.70. The boron nitride powder may have a compressive strength of 5 MPa or more.

Another aspect of the present invention is a resin composition containing a resin and the above-described boron nitride powder.

### Advantageous Effects of Invention

According to the present invention, the thermal conductivity of the boron nitride powder can be improved.

### DESCRIPTION OF EMBODIMENTS

Hereinafter, embodiments of the present invention will be described in detail.

A boron nitride powder according to an embodiment is a boron nitride powder composed of aggregates of primary particles of boron nitride. In other words, the boron nitride powder contains a plurality of aggregated boron nitride particles, and each aggregated boron nitride particle is an aggregate of a plurality of primary particles of boron nitride. The primary particles of boron nitride may be, for example, scaly hexagonal boron nitride particles. In this case, the length of the primary particles of boron nitride in the longitudinal direction, for example, may be 1 μm or more, and may be 10 μm or less.

The boron nitride powder has an average diameter (average particle diameter) of 40 μm or more. The average diameter of the boron nitride powder means a volume average diameter measured by a laser diffraction scattering method. The average diameter of the boron nitride powder is preferably 50 μm or more, more preferably, 55 μm or more, 60 μm or more, or 65 μm or more, still more preferably, 70 μm or more, 75 μm or more, or 80 μm or more, particularly preferably 85 μm or more, from the viewpoint of further improving the thermal conductivity. The average diameter of the boron nitride powder may be, for example, 150 μm or less, 120 μm or less, or 100 μm or less.

In the boron nitride powder having the above-described average diameter, by setting the average sphericity to less than 0.70, the thermal conductivity is improved. The average sphericity of the boron nitride powder is calculated as an average value of the sphericity of each of 5000 aggregated boron nitride particles, the sphericity obtained according to the following formula:

Sphericity=(Circularity)²

and the circulrity of the 5000 aggregated boron nitride particles obtained by automatic measurement using a particle image analyzer (for example, a particle shape image analyzer “PITA-4” (manufactured by Seishin Enterprise Co., Ltd.)).

It is noted that, in the measurement using the particle image analyzer, since primary particles of boron nitride desorbed from the aggregated boron nitride particles are also a measurement target, only the aggregated boron nitride particles having a particle diameter equal to or larger than a particle diameter at which the particle diameter of boron nitride measured by the total particle measurement becomes 5% in cumulative frequency (5% cumulative diameter) are used in calculating the average sphericity.

The average sphericity of the boron nitride powder is preferably 0.65 or less, more preferably 0.60 or less, still more preferably 0.55 or less, particularly preferably 0.50 or less, from the viewpoint of further improving the thermal conductivity. The average sphericity of the boron nitride powder may be, for example, 0.30 or more, 0.35 or more, or 0.40 or more.

The compressive strength of the boron nitride powder is preferably 5.0 MPa or more, more preferably 5.5 MPa or more, and even more preferably 6.0 MPa or more, from the viewpoint of suppressing a decrease in thermal conductivity due to collapse of the boron nitride powder caused by stress during kneading or pressing with a resin when the boron nitride powder is mixed with the resin and used, for example. The compressive strength of the boron nitride powder means compressive strength (also referred to as particle strength or compressive strength of a single granule) measured according to JIS R1639-5:2007. More specifically, the compressive strength (σ: MPa) is calculated from a dimensionless number (α=2.48: −) that varies depending on the position in the particle, a compressive test force (P: N), and a particle diameter (d: μm) by using an formula of σ=α×P/(π×d²).

The boron nitride powder having the above-described average diameter and average sphericity (further, compressive strength) can be produced, for example, by a production method including a pulverizing step of pulverizing a lump of boron carbide, a nitriding step of nitriding the pulverized boron carbide to obtain boron carbonitride, and a decarburizing step of decarburizing the boron carbonitride.

In the pulverizing step, the lump of carbon boron (boron carbide lump) is pulverized using a general pulverizer or disintegrator. At this time, a boron carbide powder having an average diameter of 40 μm or more and an average sphericity of less than 0.70 is obtained by shortening the pulverization time and increasing the charged amount of the boron carbide mass. The average diameter and the average sphericity of the boron carbide powder are measured in the same manner as the average diameter and the average sphericity of the boron nitride powder described above. As described above, by adjusting the average diameter (particle size distribution) and the average sphericity (particle shape) of the boron carbide powder, the average diameter (particle size distribution) and the average sphericity (particle shape) of the obtained boron nitride powder can be adjusted.

Subsequently, in the nitriding step, boron carbonitride is obtained by heating the boron carbide powder in an atmosphere in which a nitriding reaction proceeds and under a pressurized condition.

The atmosphere in the nitriding step is an atmosphere in which a nitriding reaction proceeds, and may be, for example, a nitrogen gas, an ammonia gas, or the like, and may be one of these gases alone or a combination of 2 or more thereof. The atmosphere is preferably nitrogen gas from the viewpoint of ease of nitriding and cost. The content of nitrogen gas in the atmosphere is preferably 95% by volume or more, more preferably 99.9% by volume or more.

The pressure in the nitriding step is preferably 0.6 MPa or more, more preferably 0.7 MPa or more, and is preferably 1.0 MPa or less, more preferably 0.9 MPa or less. The pressure is more preferably 0.7 to 1.0 MPa. The heating temperature in the nitriding step is preferably 1800° C. or higher, more preferably 1900° C. or higher, and is preferably 2400° C. or lower, more preferably 2200° C. or lower. The heating temperature is more preferably 1800 to 2200° C. The pressure condition and the heating temperature are preferably 1800° C. or more and 0.7 to 1.0 MPa, because the nitriding of boron carbide is more suitably progressed and the conditions are industrially suitable.

The heating time in the nitriding step is appropriately selected within a range in which nitriding sufficiently proceeds, and is preferably 6 hours or more, more preferably 8 hours or more, and is preferably 30 hours or less, more preferably 20 hours or less.

In the decarburization step, the boron carbonitride obtained in the nitriding step is subjected to a heat treatment in which the boron carbonitride is held at a predetermined holding temperature for a certain period of time in an atmosphere at normal pressure or higher. As a result, it is possible to obtain aggregated boron nitride particles (boron nitride powder) in which decarburized and crystallized primary particles of boron nitride (primary particles are scaly hexagonal boron nitride) are aggregated.

The atmosphere in the decarburization step is a normal pressure (atmospheric pressure) atmosphere or a pressurized atmosphere. In the case of a pressurized atmosphere, the pressure may be, for example, 0.5 MPa or less, preferably 0.3 MPa or less.

In the decarburization step, for example, the temperature is first raised to a predetermined temperature (a temperature at which decarburization can be started), and then the temperature is further raised to the holding temperature at a predetermined rate. The predetermined temperature (temperature at which decarburization can be started) can be set according to the system, and may be, for example, 1000° C. or more, 1500° C. or less, or preferably 1200° C. or less. The rate of raising the temperature from the predetermined temperature (temperature at which decarburization can be started) to the holding temperature may be, for example, 5° C./min or less, and preferably 4° C./min or less, 3° C./min or less, or 2° C./min or less.

The holding temperature is preferably 1800° C. or higher, and more preferably 2000° C. or higher, from the viewpoint that grain growth easily occurs well and the thermal conductivity of the obtained boron nitride powder can be further improved. The holding temperature may be preferably 2200° C. or less, more preferably 2100° C. or less.

The time for holding at the holding temperature is appropriately selected within a range in which crystallization sufficiently proceeds, and may be, for example, more than 0.5 hours. From the viewpoint of facilitating good grain growth, the time is preferably 1 hour or more, more preferably 3 hours or more, still more preferably 5 hours or more, and particularly preferably 10 hours or more. The retention time at the retention temperature may be, for example, less than 40 hours, and is preferably 30 hours or less, more preferably 20 hours or less, from the viewpoint of being able to reduce a decrease in particle strength due to excessive grain growth, and also to reduce industrial inconvenience.

In the decarburization step, a boron source may be mixed as a raw material in addition to the boron carbonitride obtained in the nitriding step to perform decarburization and crystallization. Boron sources include boric acid, boron oxide, or mixtures thereof. In this case, other additives used in the art may be further used as necessary.

The mixing ratio of boron carbonitride and the boron source is appropriately selected. When boric acid or boron oxide is used as the boron source, the proportion of boric acid or boron oxide may be, for example, 100 parts by mass or more, preferably 150 parts by mass or more, and may be, for example, 300 parts by mass or less, preferably 250 parts by mass or less, relative to 100 parts by mass of boron carbonitride.

The boron nitride powder obtained as described above may be subjected to a step of classifying the boron nitride powder having a desired size (diameter) with a sieve (classification step). As a result, a boron nitride powder having a desired size (diameter) can be more suitably obtained in a range in which the average diameter is 40 μm or more.

The boron nitride powder described above is suitably used for, for example, a heat dissipation member. When the boron nitride powder is used for a heat dissipation member, for example, the boron nitride powder is used as a resin composition mixed with a resin. That is, another embodiment of the present invention is a resin composition containing a resin and the boron nitride powder.

Examples of the resin include epoxy resin, silicone resin, silicone rubber, acrylic resin, phenol resin, melamine resin, urea resin, unsaturated polyester, fluororesin, polyimide, polyamideimide, polyetherimide, polybutylene terephthalate, polyethylene terephthalate, polyphenylene ether, polyphenylene sulfide, wholly aromatic polyester, polysulfone, liquid crystal polymer, polyethersulfone, polycarbonate, maleimide-modified resin, ABS (acrylonitrile-butadiene-styrene) resin, AAS (acrylonitrile-acrylic rubber-styrene) resin, and AES (acrylonitrile-ethylene-propylene-diene rubber-styrene) resin.

When the resin composition is used for an insulating layer of a printed wiring board, the resin is preferably an epoxy resin, more preferably a bisphenol A type epoxy resin or a naphthalene type epoxy resin, from the viewpoint of excellent heat resistance and adhesive strength to a circuit. When the resin composition is used for a thermal interface material, the resin is preferably a silicone resin from the viewpoint of excellent heat resistance, flexibility, and adhesion to a heat sink or the like.

The content of the resin may be, for example, 15% by volume or more, 20% by volume or more, 30% by volume or more, or 40% by volume or more, and may be 70% by volume or less, 60% by volume or less, or 50% by volume or less, based on the total volume of the resin composition.

The content of the boron nitride powder is, based on the total volume of the resin composition, preferably 30% by volume or more, more preferably 40% by volume or more, even more preferably 50% by volume or more, and particularly preferably 60% by volume or more, from the viewpoint of improving the thermal conductivity of the resin composition and easily obtaining excellent heat dissipation performance, and preferably 85% by volume or less, more preferably 80% by volume or less, from the viewpoint of suppressing generation of voids during molding and deterioration of insulating properties and mechanical strength.

The resin composition may further contain a curing agent for curing the resin. The curing agent is appropriately selected depending on the type of the resin. Examples of the curing agent used together with the epoxy resin include a phenol novolac compound, an acid anhydride, an amino compound, and an imidazole compound. The content of the curing agent may be, for example, 0.5 parts by mass or more or 1.0 parts by mass or more, and may be 15 parts by mass or less or 10 parts by mass or less, relative to 100 parts by mass of the resin.

### EXAMPLES

Hereinafter, the present invention will be described more specifically based on examples, but the present invention is not limited to the following examples.

### Example 1

A boron carbide powder having an average diameter of 55 μm and an average sphericity of less than 0.70 was filled in a carbon crucible, and heated in a nitrogen-gas atmosphere at 2000° C. and 0.8 MPa for 20 hours to obtain boron carbonitride (B₄CN₄). After 100 parts by mass of the obtained boron carbonitride and 200 parts by mass of boric acid were mixed using a Henschel mixer, the mixture was charged into a boron nitride crucible and heated using a resistance heating furnace at a holding temperature of 2000° C. for a holding time of 10 hours under normal pressure in a nitrogen gas atmosphere to obtain aggregated boron nitride particles in which primary particles were aggregated. The obtained boron nitride particles were crushed in a mortar for 10 minutes, and then classified with a nylon sieve having a sieve opening of 109 μm. As a result, aggregated boron nitride particles (boron nitride powder) in which the primary particles were aggregated were obtained.

### Example 2

A boron nitride powder was obtained under the same conditions as in Example 1 except that a boron carbide powder having an average diameter of 30 μm and an average sphericity of less than 0.70 was used, and the mesh size of the sieve used for classifying the boron nitride powder was changed to 75 μm.

### Example 3

A boron nitride powder was obtained under the same conditions as in Example 1 except that a boron carbide powder having an average diameter of 33 μm and an average sphericity of less than 0.70 was used, and the mesh size of the sieve used for classifying the boron nitride powder was changed to 86 μm.

### Example 4

A boron nitride powder was obtained under the same conditions as in Example 1 except that a boron carbide powder having an average diameter of 37 μm and an average sphericity of less than 0.70 was used, and the mesh size of the sieve used for classifying the boron nitride powder was changed to 86 μm.

### Comparative Example 1

An amorphous boron nitride powder having an oxygen content of 2.4%, a boron nitride purity of 96.3%, and an average particle size of 3.8 μm, a hexagonal boron nitride powder having an oxygen content of 0.1%, a BN purity of 98.8%, and an average particle size of 12.8 μm, calcium carbonate (“PC-700” manufactured by Shiraishi Kogyo Kaisha, Ltd.), and water were mixed using a Henschel mixer, and then pulverized with a ball mill to obtain an aqueous slurry. Further, 0.5 parts by mass of a polyvinyl alcohol resin (“Gohsenol” manufactured by The Nippon Synthetic Chemical Industry Co., Ltd.) was added to 100 parts by mass of the aqueous slurry, and the mixture was heated and stirred at 50° C. until dissolved, and then spheroidized at a drying temperature of 230° C. in a spray dryer. A rotary atomizer was used as a sphering device of the spray dryer. The obtained treated product was heated in a batch-type radio frequency oven, and then the heated product was subjected to crushing and classification treatment to obtain a boron nitride powder.

[Measurement of Average Diameter]

The average diameter (volume average diameter) of each of the obtained boron nitride powders was measured using a laser diffraction scattering particle size distribution analyzer (LS-13 320) manufactured by Beckman Coulter, Inc.

[Measurement of Average Diameter, Average Sphericity, and Compressive Strength]

The circularity of each of the obtained boron nitride powders was calculated as an average value of the sphericity of each of 5000 aggregated boron nitride particles, in which the sphericity was obtained according to the following formula:

Sphericity=(Circularity)²

and the circulrity of the 5000 aggregated boron nitride particles was obtained by automatic measurement using a particle image analyzer (for example, a particle shape image analyzer “PITA-4” (manufactured by Seishin Enterprise Co., Ltd.)).

It is noted that, in the measurement using the particle image analyzer, since primary particles of boron nitride desorbed from the aggregated boron nitride particles were also a measurement target, only the aggregated boron nitride particles having a particle diameter equal to or larger than a particle diameter at which the particle diameter of boron nitride measured by the total particle measurement becomes 5% in cumulative frequency (5% cumulative diameter) were used in calculating the average sphericity.

[Measurement of Compressive Strength]

The compressive strength of each of the obtained boron nitride powders was measured according to JIS R1639-5:2007. A micro compression tester (“MCT-W500”, manufactured by Shimadzu Corporation) was used as a measurement apparatus. The compressive strength (σ: MPa) was calculated from a dimensionless number (α=2.48: −) that varies depending on the position in the particle, a compressive test force (P: N), and a particle diameter (d: μm) by using an formula of σ=α×P/(π×d²).

[Measurement of Heat Conductivity]

The obtained boron nitride powder was mixed with a mixture of 100 parts by mass of naphthalene type epoxy resins (HP 4032, manufactured by DIC Corporation) and 10 parts by mass of imidazoles (2E4MZ-CN, manufactured by Shikoku Chemicals Corporation) as a curing agent to obtain a resin composition in which the boron nitride powder is 50% by volume. This resin composition was applied onto a PET sheet to a thickness of 1.0 mm, and then defoamed under reduced pressure of 500 Pa for 10 minutes. Thereafter, the sheet was pressed and heated at a temperature of 150° C. under a pressure of 160 kg/cm² for 60 minutes to prepare a sheet having a thickness of 0.5 mm.

A measurement sample having a size of 10 mm×10 mm was cut out from the obtained sheet, and the thermal diffusivity A (m²/sec) of the measurement sample was measured by a laser flash method using a xenon flash analyzer (LFA 447 NanoFlash manufactured by NETZSCH). The specific gravity B (kg/m³) of the measurement sample was measured by the Archimedes method. The specific heat capacity C (J/(kg·K)) of the measurement sample was measured using a differential scanning calorimetry (DSC; ThermoPlusEvo DSC 8230, manufactured by Rigaku Corporation). Using these physical properties, the thermal conductivity H (W/(m·K)) was determined from the formula H=A×B×C. The results are shown in Table 1.

TABLE 1

| | Exam- | Exam- | Exam- | Exam- | Comparative |
|---|---|---|---|---|---|
| | ple 1 | ple 2 | ple 3 | ple 4 | Example 1 |
| Average | 87.4 | 43.0 | 54.9 | 66.9 | 71.6 |
| Diameter (μm) | | | | | |
| Average | 0.49 | 0.59 | 0.44 | 0.47 | 0.70 |
| Sphericity | | | | | |
| Compressive | 6.9 | 10.0 | 10.3 | 5.9 | 2.0 |
| Strength (MPa) | | | | | |
| Heat | 19.4 | 14.7 | 12.6 | 15.0 | 11.9 |
| Conductivity | | | | | |
| (W/(m · K)) | | | | | |

1. A boron nitride powder composed of aggregates of primary particles of boron nitride, wherein the boron nitride powder has an average diameter of 40 μm or more and an average sphericity of less than 0.70.

2. The boron nitride powder according to claim 1, wherein the boron nitride powder has a compressive strength of 5 MPa or more.

3. A resin composition comprising:
a resin; and
the boron nitride powder according to claim 1.
